(19) United States
(12) Patent Application Publication
(10) Pub. No.: US 2008/0033859 A1
(43) Pub. Date: Feb. 7, 2008

(54) Profit attribution modeling system

(76) Inventor: Andrew John Olsen, Fort Myers, FL (US)

Correspondence Address: ANDREW JOHN OLSEN, NMSI, P.O. Box 547, FORT MYERS, FL, 33902, US

(21) Appl. No.: 11/879,154

(22) Filed: Jul. 16, 2007

(30) Foreign Application Priority Data
Jul. 19, 2006 (AU) 2006903912

(51) Int. Cl. G06Q 40/00

(52) U.S. Cl. 705/36 R

(57) ABSTRACT

A profit attribution modelling system adapted to model the effect on profitability of a business caused by effective investment in any one or more of number of factors. The system displays the representations of the factors, enters a value representing the profit level of the business, enters a value representing a proposed investment value in any one of the factors where a predicted profitability is computed in response to the altered factor and based upon a predetermined scale of interrelationships between the factors.

### FIELD OF THE INVENTION

The present invention relates to a system for estimating and predicting the financial benefit accruing to a business from effective investment in various factors related to human interaction within a business. It also relates to a method of for assessing and displaying the effect on profitability of a business caused by effective investment in any one or more of a plurality of factors concerning human interaction between personnel employed by the business.

### BACKGROUND ART

Most modern businesses employing more than a few personnel rely on the performance of those personnel for the profitability of the business. The demands on personnel have become more complex and it has long been recognized that intelligent and harmonious interaction between personnel is essential to the successful operation of the business. Business development consultants have analysed various aspects of that interaction and have often recommended to businesses that they take steps to improve at least certain aspects of that interaction. However, until now, it has been impractical to predict with any confidence the value of any benefit that might result from any expenditure made to improve some aspect of human interaction with a business.

Recently, there have been a number of studies published which have attempted to quantify the effect on profitability that are made by the various factors affecting human interaction. In particular, David H Maister has described a rather comprehensive empirical relationship between profitability and various interaction factors as discovered in a very large study across a substantial number of businesses. This study has shown that profitability is directly connected to and predicted by the scores that staff give on approximately 70 survey questions.

While it has been appreciated that such studies provide valuable insights into the interactions within a business, the application of such information to a business to improve profitability has previously been an ad hoc process due to the complexity of the interactions and the difficulty in predicting the result in a monetary form.

### DISCLOSURE OF THE INVENTION

Accordingly, the invention resides in a profit attribution modelling system adapted to model the effect on profitability of a business caused by effective investment in any one or more of a plurality of factors, the system comprising a means of displaying representations of said plurality of factors, means for entering a value representing the profit level of the business, means of entering a value representing a proposed investment value in any one of said factors and computing means whereby a predicted profitability is computed in response to the altered factor and based upon a predetermined scale of interrelationships between said factors.

According to a preferred embodiment, the system permits entry of values against more than one factor before the predicted profitability is computed.

According to a preferred feature of the invention, the system comprises means for entry of the predetermined scale of interrelationships.

According to a preferred embodiment, the computing means comprises an electronic computer and the display comprises a computer monitor, the system further comprising a computer program adapted to cause the monitor to display representations of said factors on said computer monitor, and to enable input of said values to be received and to display on said computer monitor, the program causing computation of said predicted profitability.

According to a preferred feature of the invention, the scale of interrelationships between said factors is determined by reference to a study of the profitability performance of selected organisations over a study period, wherein factor scores existing in those organisations during the study period are identified, averages for the factor scores for the selected organisations are determined and whereby average correspondences between the factor scores and profitability are determined. According to a preferred embodiment, profitability and factor scores of the group identified by the study are compared to the average results of the selected organisations. According to a preferred embodiment, the factor scores of the group are compared with average factor scores derived from the study of the selected organisations to establish a deviation for each factor score. According to a preferred embodiment, fields are provided for displaying said deviations.

According to a preferred feature of the invention, the system provides a prediction on the variation of profitability of the group according to a proposed investment in a selected factor directed to producing a change in the value of that factor.

According to a preferred feature of the invention, the system comprises a database program. According to a preferred embodiment, the database program comprises a spreadsheet program.

According to a preferred embodiment, the input and display of the data is by a display program separate from the database program.

According to a preferred embodiment, the display of the data is presented as a dashboard comprising a plurality of analogue representations of the relative values to be displayed. According to a preferred embodiment, analogue representations are in the form of dials. According to a preferred embodiment, fields are included within the dials to display and/or input numerical values corresponding to the dials.

According to a further aspect, the invention resides in a method for assessing and displaying the effect on profitability of a business caused by effective investment in any one or more of a plurality of factors concerning human interaction between personnel employed by the business, the method comprising the steps of:
a. identifying a group of staff of an organisation required for study;
b. having the members of the group participate in a survey where they rate aspects of the work life according to a plurality of predefined factors;
c. entering the responses of the survey into a computer database program and storing the information;
d. summarizing the accumulated results into factor scores using formulae that have previously been derived to relate the factors;
e. relating said factor scores to the profitability of the group;
f. identifying changes in profitability that will be caused by causing changes in on or more of said factor scores.

According to a preferred feature of the invention, the formulae are derived from the factors identified by a statistical procedure known as ‘factor analysis’.

According to a preferred feature of the invention, the formulae are determined by reference to a study of the profitability performance of selected organisations over a study period, identifying factor scores existing in those organisations during the study period, determining average for the results for the selected organisations and determining an average correspondence between the factor scores and profitability.

According to a preferred feature of the invention, profitability and factor scores of the group identified by the study are compared to the average results of the selected organisations.

According to a preferred feature of the invention, the factor scores of the group are compared with average factor scores derived from the study of the selected organisations to establish a deviation for each factor score.

According to a preferred feature of the invention, a computer system is used to provide a prediction on the variation of profitability of the group according to a proposed investment in a selected factor, as a result of the formulae.

According to a preferred feature of the invention, the user can directly change the factor score that shows on any one or combination of dials, thereby causing the software to use the formulae to recalculate changes in the above-mentioned values that are associated with the revised factor score changes to thereby allow the user to explore various intervention scenarios.

According to a preferred feature of the invention, the results in changes in factor scores caused by proposed investments are used to calculate and display ‘Return on Investment’ figure to thereby enable the user to compare the relative value of alternative investments in strategies designed to improve the working experience of staff.

According to a preferred embodiment, the factors relate to human interaction between personnel employed by the business. According to a preferred embodiment, the factors concerning human interaction are selected from employee ratings of at least factors such as Customer Service, Engagement, Consequences, Coaching, Empowerment, Fair Pay, Regard, Big Picture Thinking and Training

According to a preferred embodiment, the factors relate to customer perception of a product or service business or market. According to a preferred embodiment, the factors concerning customer satisfaction are selected from customer ratings of at least factors such as Customer Service, Proximity, Range, Cleanliness, Loyalty Cards, Rewards System, Green Products and Facilities. According to a preferred embodiment, the product is an automobile and the factors concerning customer satisfaction are selected from customer ratings of at least factors such as Appearance, Quality, Reliability, Power, Handling, After-Sales Service, Parts Prices and Resale Value.

The invention will be more fully understood in the light of the following description of one preferred embodiment.

### BRIEF DESCRIPTION OF THE DRAWINGS

The description is made with reference to the accompanying drawings, of which:

FIG. 1 is a diagrammatic representation of the components of a computer system according to the embodiment;

FIG. 2 is a diagrammatic representation of the interrelationships concerning human interaction between personnel employed by the business;

FIG. 3 is a drawing of the features displayed on the monitor of a computer according to the first embodiment;

FIG. 4 is a first representation of the panel displayed on a monitor in the first phase of execution of a program of the embodiment of the invention;

FIG. 5 is a representation of the panel of FIG. 3 when operating in a second phase;

FIG. 6 is an alternative representation of the panel of FIG. 5 when operating in a second phase;

FIG. 7 is a representation of the panel of FIG. 3 when operating in a third phase; and

FIG. 8 is a representation of the panel as shown FIG. 5 further encompassing arrows indicating the interrelationships which are calculated by the program of the embodiment.

### DETAILED DESCRIPTION OF PREFERRED EMBODIMENT

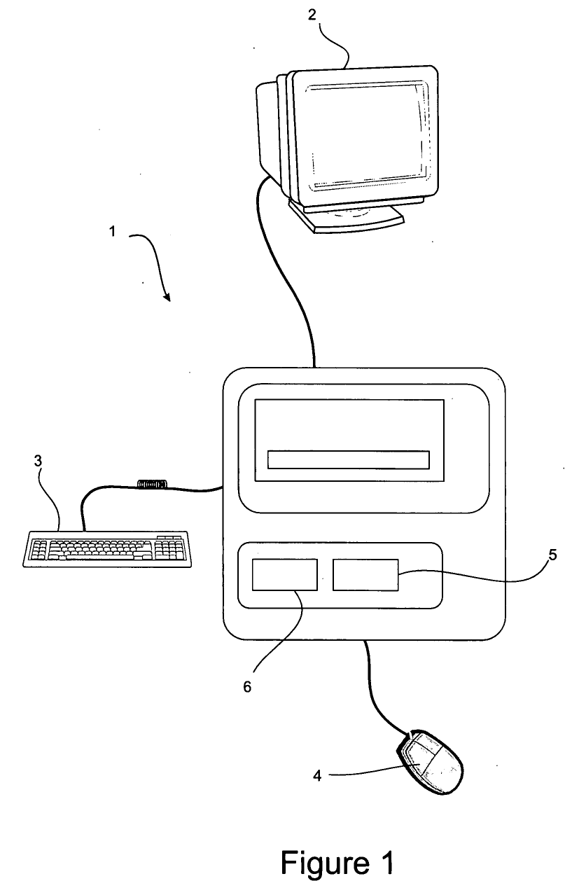

The embodiment of the invention is described with reference firstly to FIG. 1 and comprises a program for a computer system 1 having a display means in the form of a computer monitor 2, input means comprising a key board 3 and a device capable of controlling a cursor representation on the monitor such as a computer mouse 4, a central processing means 5 to enable processing of a computer program and computation of results. The program is typically stored on the hard disc 6 of the computer.

The computer program of the embodiment is directed to determining and displaying interactively the profit which is predicted to result from effective investment in one of more of factors concerning human interaction between personnel employed by the business. The particular factors and their interrelationship that are used within the embodiment are derived from those identified by David H Maister in his book “Practice What You Preach: What Managers Must Do To Create A High Achievement Culture” (2001 Free Press Simon & Schuster NY, ISBN 0-7432-1187-1). The embodiment also provides a method of predicting and displaying the effect on profitability of a business caused by effective investment in any one or more of a plurality of factors concerning human interaction between personnel employed by the business.

This system and method enable interactive use in a way that is easily comprehended by an unskilled person viewing the displayed results. The interactive nature enables a user to first try one effective investment strategy and thereafter view the predicted results and then try an alternative strategy and view the alternative results. The system comprises a means for displaying representations of said plurality of factors, means for entering a value representing the profit level of the business, means of entering a value representing a proposed effective investment value in any one of said factors and computing means whereby an estimated or predicted profitability is computed in response to the altered factor and based upon a predetermined scale of interrelationships between said factors.

The factors identified by Maister are listed below.
A. Training & Development;
B. Long-term Organisation
C. Enthusiasm, Commitment & Respect;
D. Fair compensation;
E. Empowerment
F. Coaching
G. High Standards
H. Employee Satisfaction;
I. Quality & Client Relationships

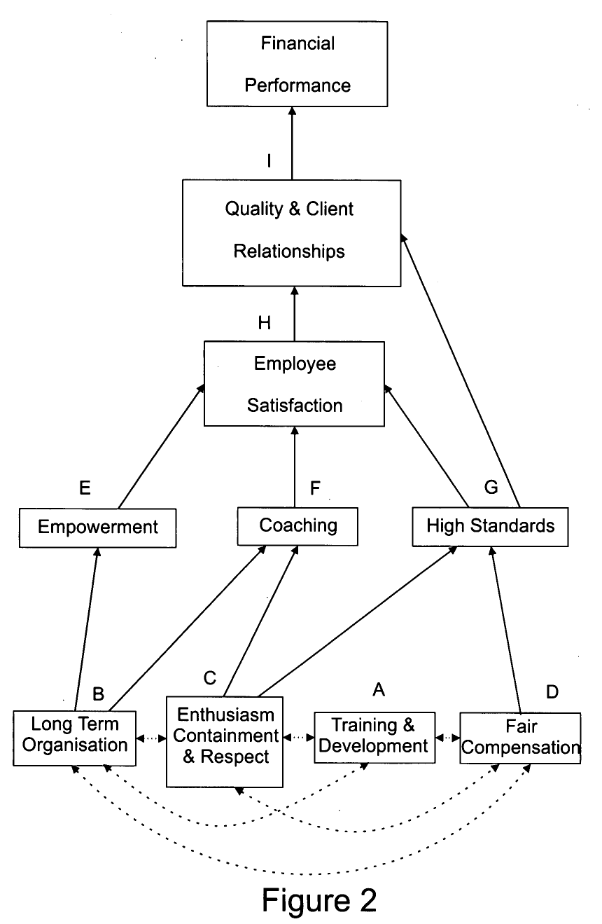

Maister has identified that these factors are interrelated by a complex set of relationships—if one item is varied then in most cases more than one of the other factors is directly affected. These interrelationships are illustrated in FIG. 2. This set of interrelationships is difficult to apply in a conventional manner.

Maister's factors have been adopted within the embodiment and re-defined as shown below:

| | Factor | Description |
|---|---|---|
| A | Training Ethos 21 | Skilling/training opportunities, |
| | | high quality is required; |
| | | Managers committed to training |
| B | Big Picture Ethos 22 | Strategic clarity, long term |
| | | thinking, effective investment |
| | | in long term future |
| C | Regard Loyalty 23 | Mutual respect, boss able to |
| | | get best from each one, boss |
| | | earns loyalty, high morale |
| D | Just Rewards (Pay) 24 | Recognition and financial |
| | | reward is fair, goes where is |
| | | deserved, including in my case |
| E | Empowerment 25 | Authority delegated, initiative |
| | | stimulated, openness is |
| | | encouraged |
| F | Coaching Smarts 26 | Supervisor is highly trusted |
| | | coach, close conversations, |
| | | fosters team health |
| G | Consequence Ethos 27 | Very high skills and |
| | | standards, poor performance |
| | | is not tolerated |
| H | Engagement 28 | feel challenged, achievement, |
| | | satisfaction, committed to |
| | | career here |
| I | Client-Servant Ethos 29 | Consistently superior product |
| | | and service in actual practice, |
| | | sacrifice for client |

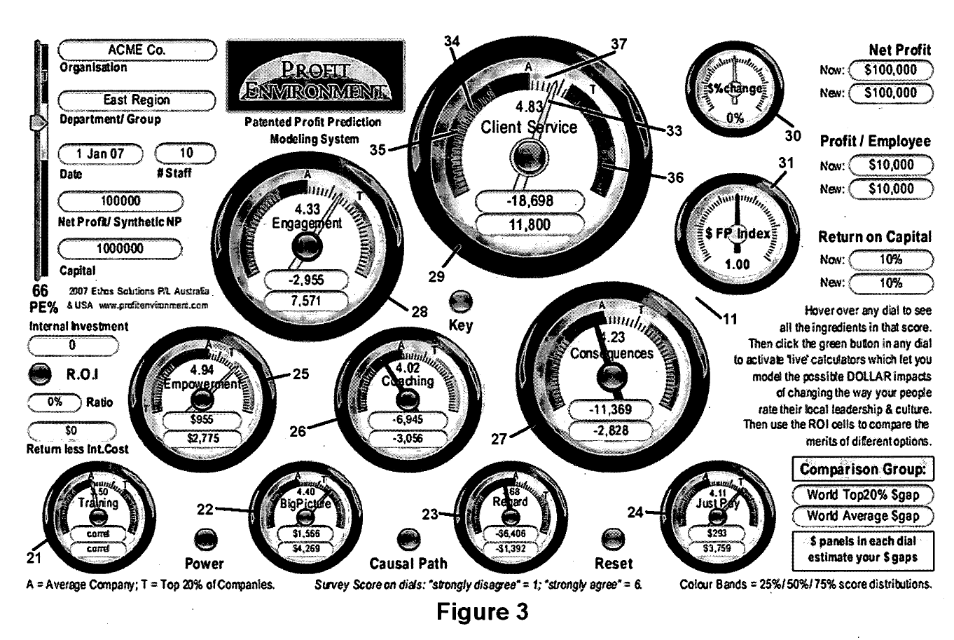

To aid visualisation of these factors the level of the nine factors are represented graphically. In the embodiment, when the program is executed, a display is given which is initially in the form of FIG. 3. As shown in FIG. 3, the program of the embodiment displays a panel 11 with a group of 11 circular icons representing the nine factors 21-29, plus a % change icon 30 representing the percentage change that occurs when a new calculation is made and a $FP icon 31 to represent the financial performance index of the business. Each dial (in the drawings, as enumerated for the Client-Servant Ethos 29, only) has a radially oriented indicating member 33 and a graduated scale 34 to generally represent dial gauges of the type commonly in use in the automotive industry or industrial industry. The graduated scale has six major markings 35 and a plurality of minor markings 36 subdividing the major scale. Distinguishing coloured markings 37 on the graduated area help a user to identify an average or median level and the quartile levels for that particular factor. It will be appreciated that representations enable a graphical representation to be given of the relative level of each factor. It will also be recognised that although this embodiment has selected representations of dial gauges as the means to graphically represent the relative value of a factor, alternative representations such as a columnar bar chart might also be chosen.

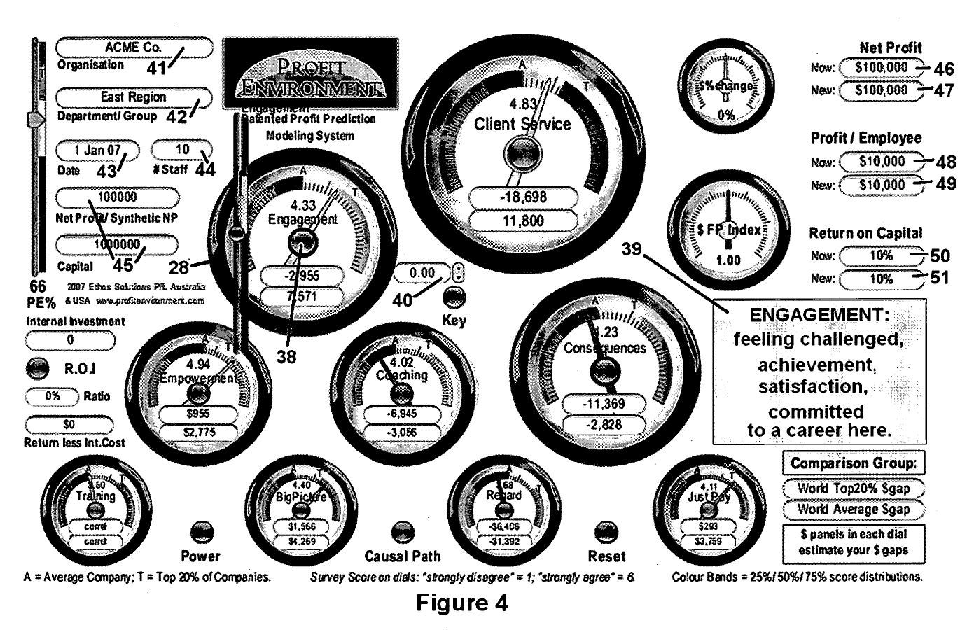

The display panel 11 will also typically have identification markings (not shown) to identify the business consultant and descriptive text explaining certain aspects of the display panel 11. Optionally, additional explanatory text is displayed within a text box upon the display panel 11 upon initiating an appropriate trigger—in the embodiment, being a button within the centre of each of the nine icons 21-29. FIG. 4 shows the display panel after the central button 38 of the Engagement icon 28 has been triggered to display a text panel 39 with an explanation of the Engagement icon. In addition, it will be seen that a further numeric display 40 field is displayed together with an up-down arrow pair. The purpose of this field is discussed later in this specification.

When the program is first run, it is populated with a set of data values for each factor which represent the state of the business under consideration. These factors are determined by a business consultant in advance, and in the preferred embodiment these factors are a set of factors based upon Maisters factors. The financial information at the time will be ascertained from the client. The business consultant will also have undertaken a survey by means of a questionnaire to assess the status of each of the abovementioned factors as perceived by the employees according to predetermined criteria. The response scales read as follows:
1=Strongly Agree
2=Disagree
3=Somewhat Disagree
4=Somewhat Agree
5=Agree
6=Strongly Agree

These responses are reflected on the respective dial gauges by the major markings 35.

The data may be entered by means of a data entry screen (not shown), or may alternatively be read from a pre-established data file accessed by the program. According to one adaptation, the data is read from a data file if it is found on the computer or else a data entry screen is displayed. After the data is entered, it is then saved into a data file which then accessed by the program. In this way, it is not necessary to re-enter data once it has been entered a first time.

The display panel 11 also displays a series of display fields 41 representing the various data items concerning the particular business being considered. The data items shown on FIG. 3 are:

| Organisation name 41 | |
|---|---|
| Name of department or group of the organisation 42 | |
| Date 43 | |
| Number of staff 44 | |
| Capital of the Organisation 45 | |
| Net profit | now 46 |
| | new 47 |
| Profit/employee | now 48 |
| | new 49 |
| Return on Capital | now 50 |
| | new 51 |

Net profit/Synthetic NP 52

A typical procedure undertaken by the business consultant in obtaining data and using the embodiment might follow the steps listed below.
1. A group of staff are identified for study.
2. These individuals each take a survey, optionally by pen-&-paper or web-based, in which they rate many aspects of their work life on a response scale (in this case, around 80 items on a 6 point scale).
3. These responses are entered into a computer spreadsheet and stored.
4. The responses are then summarized into ‘factor scores’ using a formula derived from the factors identified from the original research by the statistical procedure known as ‘factor analysis’ (in the Maister case, 10 factors emerged).
5. The average factor scores found in the original database are subtracted from this new group's factor scores to give a score distance (+ or −) on each factor.
6. This score distance is entered, along with a real or hypothetical net profit figure for that group, into another formula that calculates for each factor separately the probable dollar value of each distance based on the structural equation model that was created in the original research (in this case, Maister's) to show the causal paths of profit.
7. The same procedure is used to calculate a score distance from the factor scores of the most profitable businesses in the original database (e.g., the top 20% of performers, or the industry benchmark), rather than the score distance from the average.
8. A dashboard software product is used, for example “Crystal Xcelcius” provided by Business Objects SA to take data from the cells in the spreadsheet containing the factor scores for each factor and display them on a radial dial.
9. The same software is used to take each of the dollar values described in the above steps and display them in 2 panels within the same dials.
10. By using a computer mouse arrow to move a slider and/or a toggle on the same dashboard display software, the user can directly change the factor score that shows on any one or combination of dials, thereby causing the software to use the structural equation modelling formulas to recalculate changes in the abovementioned dollar values (including a new net profit figure) that are associated with the revised factor score changes. This allows the user to explore various intervention scenarios.
11. By entering a dollar value into the ‘Investment’ field on the dashboard, the abovementioned changes to one or more dollar values on the factor dials and/or the net profit figure are entered into a formula and used to calculate a ‘Return on Investment’ figure that shows in the ROI field on the dashboard. This allows the user to compare the relative value of alternative investments in strategies designed to improve the working experience of staff in order to optimize well-being, productivity and profit.

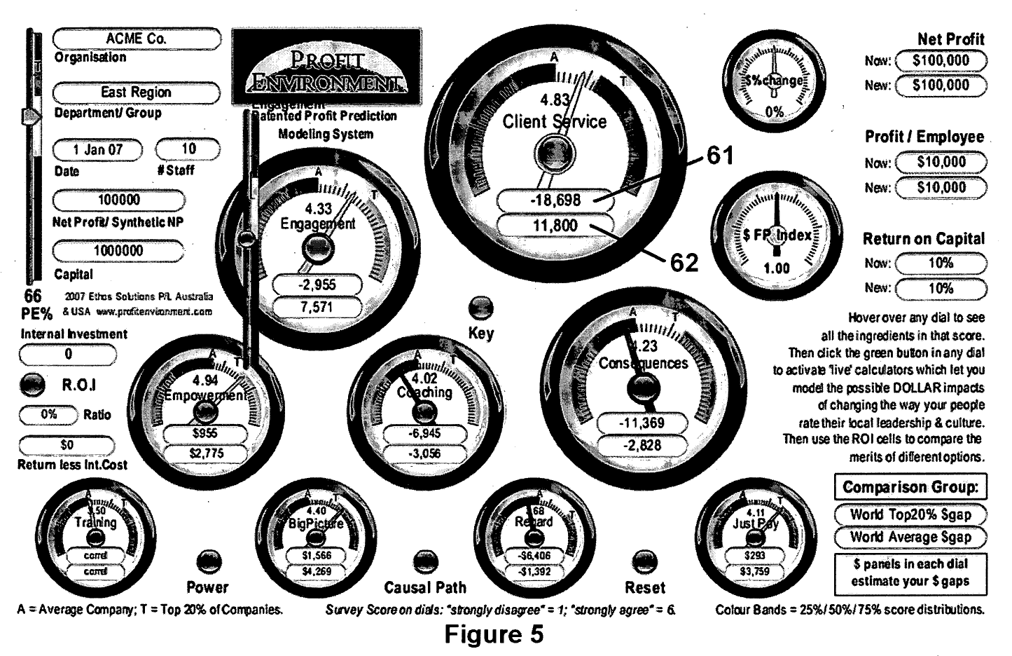

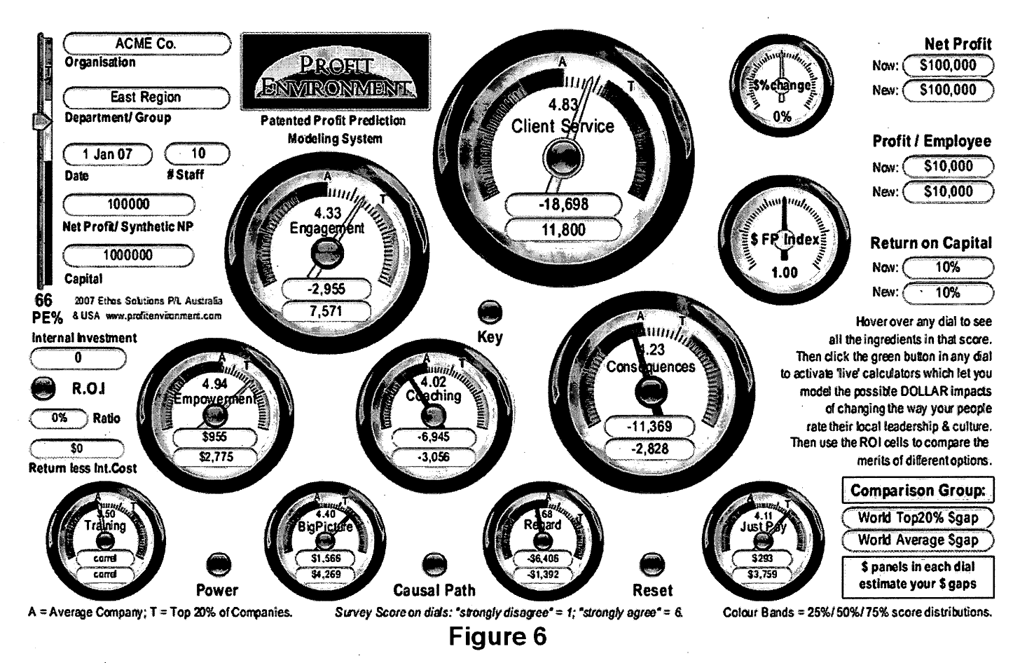

This information described above provides the observer with a financial overview of the business under consideration. After the consultant has discussed the figures with his client, the program can then be signalled to go into a second phase, as shown in FIG. 5 and FIG. 6. In the second phase, two additional numeric display fields are provided in the centre of each of the factor icons 21-29, an upper field 61 and a lower field 62. As shown in FIG. 5, the additional pair of numeric display fields may be signalled to be displayed in relation to one icon at a time, or alternatively, they may be caused to all display at once as shown in FIG. 6.

The computer program performs a comparison of the value represented on the dial against a corresponding stored value that represents the extent to which that company's net profit is currently attributable to that factor, based on the causal relationships between the factors and net profit derived from the study of Maister.

The upper field 61 displays a comparison relative to the corresponding value derived by the top 20 businesses of the world as identified by Maister in his study, while the lower display field 62 displays a comparison relative to the corresponding value derived by all businesses of Maister's study. This comparison thereby provides the client with guidance of where further effective investments should best be made.

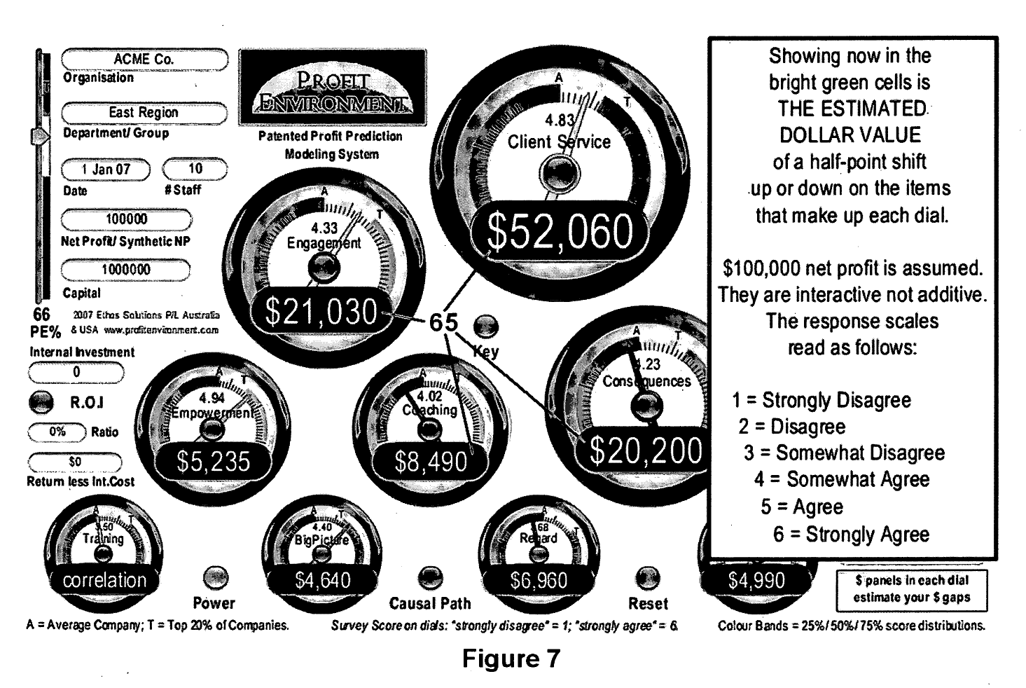

After the consultant has discussed the figures with his client, the program can then be signalled to go into a third phase, as shown in FIG. 7. In the third phase, the program causes to be displayed within each of the factor icons, a single display field 65. In this field there is displayed a value calculated by the program that represents the change in profit that would result if the business was to cause a shift in performance of a particular factor by a predetermined amount (for instance, by half of the distance between consecutive major markings 35). Again, the display fields 65 may be caused to be display successively or all together as shown in FIG. 7.

In each of the phases, when the central button of any of the factor icons is activated, a numeric display field appears together with an up-down arrow pair. Initially, the value display in this field is 0. If the up arrow is activated by a single click, the reading of the indicating member on the corresponding factor icon will be advanced by one minor graduation on the scale. The program will then calculate and display values in the fields: Net profit—new 47, Profit/employee—new 49 and Return on Capital—new 51. As well, new values will be calculated and displayed for each of factor icons, according to the predetermined interrelationships liking the factors. Also, if a dollar figure has been entered into the ‘Investment’ cell, the ‘Return on Investment’ cell will show a recalculated dollar value. In this way, the effect on the business of effective investment in any one or more of the factors can be considered and assessed in a way that is readily visualised, as well as being expressed in dollar values. This analysis can be conducted in an interactive manner, repetitively until the client is satisfied with the predicted outcome.

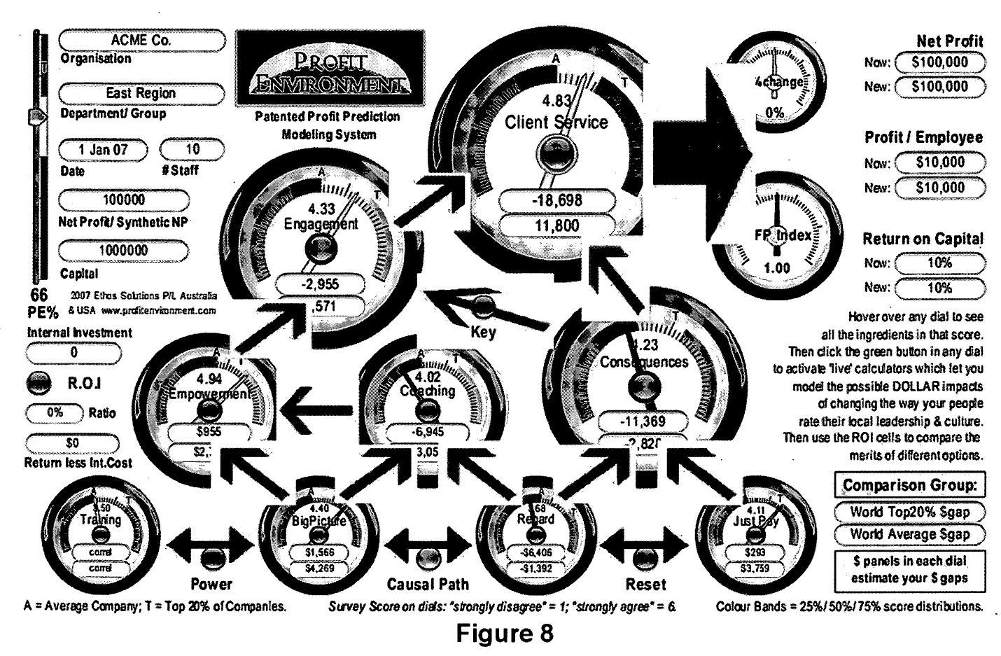

It will be appreciated that the program of the embodiment must perform calculations which reflect the interrelationships identified by Maister and shown in FIG. 2. The interrelationships of the program are illustrated in FIG. 8. The various arrows shown in FIG. 8 identify the way in which the factors are interconnected. The arithmetic values determined by Maister are then used to calculate the particular values and relative values of each factor. The program of the embodiment includes coding whereby these calculations are performed.

It can be seen from the above that the preferred use of the embodiment is the calculation of monetary values for each of the causal factors of the profit of a group. Another variation covered by this invention is the use of the identical procedure to calculate monetary values for the causal factors of buyer spending. For example, structural equations showing the causal path of factors involved in buying a product (say, from surveys of people intending to buy a car) could calculate the monetary value of each causal factor and could also do so via live modelling. The only visible difference between this adaptation and the embodiment described is that the dial labels and definitions would be have a different appearance.

Those skilled in the art will recognize that there are a number of ways to implement the invention. It will be recognized that the embodiment incorporates a database in which the values of various parameters are stored and a “front-end” enabling relevant data to be input, selected and displayed by computer according to the various functions defining the interrelationships as discussed above. Implementation of such a system might be achieved by traditional programming techniques for such systems. However, such techniques require a skilled operator to modify the parameters. According to the embodiment, the database facility is provided by means of a proprietary spreadsheet program such as the program Excel supplied by Microsoft Corporation. This program enables data to be stored in “cells” and the results of calculations to be placed in other cells. Functions and interrelationships are easily established and modified. However, while setting up the spreadsheet with such a program is relatively straightforward, the manner of presentation of the information is rather limited. Preferably, another program is used to display and input the data held in the spreadsheet program. In the embodiment, the presentation program “PowerPoint” of Microsoft Corporation is used to provide this function. In the embodiment, a third program, “Crystal Xcelcius” provided by Business Objects SA is used to provide the interconnection between the two Microsoft programs. As a result, the time required by a skilled programmer is substantially reduced or even eliminated, as these programs are designed to be used by people who are not programming professionals.

It is to be realised that the description of the invention as given above with respect to the embodiment may be adapted in many ways. For instance, while particular set of factors and their interrelationships proposed by Maister have been derived from extensive study and are considered by the Applicant to be particularly suited for the purpose of the present embodiment, it will be recognized that the invention is not restricted to the factors and interrelationships of Maister. Should other studies identify other factors and/or interrelationships, the embodiment may be easily amended to adopt the alternative factors and interrelationships. Further, it will also be recognised that although this embodiment has selected representations of dial gauges as the means to graphically represent the relative value of a factor, alternative representations such as a columnar bar chart might also be chosen. It is to be appreciated that all such adaptations are to be considered as being within the scope of the invention as herein described.

However, it will also be appreciated that invention may be adapted more broadly than the adaptations of the embodiment as described above. It is to be appreciated that the invention may be applied in other ways than by the assessment of employee perceptions and the factors considered may be quite different from those given above. For instance, embodiment may be adapted to consider the perceptions of customers of a business. Customers surveys may be conducted to ascertain customer perception of the business judged against a number of factors. The factors might be slected to be appropriate for the particular kind of business. In a product directed business they might comprise Customer Service, Proximity, Range, Cleanliness, Loyalty Cards, Rewards System, Green Products and Facilities. Typical factors might be modified for assessment of a service business. This list of factors may be further adapted for specific industries. For instance, if an automotive business is considered, the factors might be Appearance, Quality, Reliability, Power, Handling, After-Sales Service, Parts Prices and Resale Value. As in the embodiment, the relationship between the factors and the profitability is determined from a relevant study of the industry to provide a standard against which a particular industry can be compared and to ascertain the interactions existing between the factors.

Throughout the specification, unless the context requires otherwise, the word “comprise” or variations such as “comprises” or “comprising”, will be understood to imply the inclusion of a stated integer or group of integers but not the exclusion of any other integer or group of integers.

The claims defining the invention are as follows:

1. A profit attribution modelling system adapted to model the effect on profitability of a business caused by effective investment in any one or more of a plurality of factors, the system comprising a means of displaying representations of said plurality of factors, means for entering a value representing the profit level of the business, means of entering a value representing a proposed investment value in any one of said factors and computing means whereby a predicted profitability is computed in response to the altered factor and based upon a predetermined scale of interrelationships between said factors.

2. A profit attribution modelling system as claimed at claim 1 wherein the system permits entry of values against more than one factor before the predicted profitability is computed.

3. A profit attribution modelling system as claimed at claim 1 wherein the system comprises means for entry of the predetermined scale of interrelationships.

4. A profit attribution modelling system as claimed at claim 1 wherein the computing means comprises an electronic computer and the display comprises a computer monitor, the system further comprising at least one computer program adapted to cause the monitor to display representations of said factors on said computer monitor, and to enable input of said values to be received and to display on said computer monitor, the program causing computation of said predicted profitability.

5. A profit attribution modelling system as claimed at claim 1 wherein the scale of interrelationships between said factors is determined by reference to a study of the profitability performance of selected organisations over a study period, wherein factor scores existing in those organisations during the study period are identified, averages for the factor scores for the selected organisations are determined and whereby average correspondences between the factor scores and profitability are determined.

6. A profit attribution modelling system as claimed at claim 5 wherein profitability and factor scores of the group identified by the study are compared to the average results of the selected organisations.

7. A profit attribution modelling system as claimed at claim 6 wherein the factor scores of the group are compared with average factor scores derived from the study of the selected organisations to establish a deviation for each factor score.

8. A profit attribution modelling system as claimed at claim 7 wherein fields are provided for displaying said deviations.

9. A profit attribution modelling system as claimed at claim 7 wherein the system provides a prediction on the variation of profitability of the group according to a proposed investment in a selected factor directed to producing a change in the value of that factor.

10. A profit attribution modelling system as claimed at claim 1 wherein the system comprises a database program.

11. A profit attribution modelling system as claimed at claim 10 wherein the database program comprises a spreadsheet program.

12. A profit attribution modelling system as claimed at claim 10 wherein the input and display of the data is by a display program separate from the database program.

13. A profit attribution modelling system as claimed at claim 1 wherein the display of the data is presented as a dashboard comprising a plurality of analogue representations of the relative values to be displayed.

14. A profit attribution modelling system as claimed at claim 13 wherein analogue representations are in the form of dials.

15. A profit attribution modelling system as claimed at claim 14 wherein fields are included within the dials to display and/or input numerical values corresponding to the dials.

16. A profit attribution modelling system as claimed at claim 1 wherein the factors relate to human interaction between personnel employed by the business.

17. A profit attribution modelling system as claimed at claim 16 wherein the factors concerning human interaction are selected from employee ratings of at least factors such as Customer Service, Engagement, Consequences, Coaching, Empowerment, Fair Pay, Regard, Big Picture Thinking and Training

18. A profit attribution modelling system as claimed at claim 1 wherein the factors relate to customer perception of a product or service business or market.

19. A profit attribution modelling system as claimed at claim 18 wherein the factors concerning customer satisfaction are selected from customer ratings of at least factors such as Customer Service, Proximity, Range, Cleanliness, Loyalty Cards, Rewards System, Green Products and Facilities.

20. A profit attribution modelling system as claimed at claim 18 wherein the product is an automobile and the factors concerning customer satisfaction are selected from customer ratings of at least factors such as Appearance, Quality, Reliability, Power, Handling, After-Sales Service, Parts Prices and Resale Value.

21. A method for assessing and displaying the effect on profitability of a business caused by effective investment in any one or more of a plurality of factors, the method comprising the steps of:
a) identifying for study a relevant group related to the business;
b) having the members of the group participate in a survey where they rate aspects of the business according to a plurality of predefined factors;
c) entering the responses of the survey into a computer database program and storing the information;
d) summarizing the accumulated results into factor scores using formulae that have previously been derived to relate the factors;
e) relating said factor scores to the profitability of the group;
f) identifying changes in profitability that will be caused by causing changes in on or more of said factor scores.

22. A method as claimed at claim 21 wherein the formulae are derived from the factors identified by a statistical procedure known as ‘factor analysis’.

23. A method as claimed at claim 22 wherein the formulae are determined by reference to a study of the profitability performance of selected organisations over a study period, identifying factor scores existing in those organisations during the study period, determining average for the results for the selected organisations and determining an average correspondence between the factor scores and profitability.

24. A method as claimed at claim 23 wherein profitability and factor scores of the group identified by the study are compared to the average results of the selected organisations.

25. A method as claimed at claim 24 wherein the factor scores of the group are compared with average factor scores derived from the study of the selected organisations to establish a deviation for each factor score.

26. A method as claimed at claim 25 wherein a computer system is used to provide a prediction on the variation of profitability of the group according to a proposed investment in a selected factor, as a result of the formulae.

27. A method as claimed at claim 21 wherein the computer database program is a spreadsheet program.

28. A method as claimed at claim 21 wherein the display of the data is presented as a dashboard comprising a plurality of analogue representations of the relative values to be displayed.

29. A method as claimed at claim 28 wherein analogue representations are in the form of dials.

30. A method as claimed at claim 29 wherein fields are included within the dials to display and/or input numerical values corresponding to the dials.

31. A method as claimed at claim 29 wherein the user can directly change the factor score that shows on any one or combination of dials, thereby causing the software to use the formulae to recalculate changes in the abovementioned values that are associated with the revised factor score changes to thereby allow the user to explore various intervention scenarios.

32. A method as claimed at claim 31 wherein the results in changes in factor scores caused by proposed investments are used to calculate and display ‘Return on Investment’ figure to thereby enable the user to compare the relative value of alternative investments in strategies designed to improve the working experience of staff.

33. A method as claimed at claim 21 wherein the factors relate to human interaction between personnel employed by the business and the members of the group comprise members staff of an organisation.

34. A method as claimed at claim 33 wherein the factors concerning human interaction are selected from employee ratings of at least factors such as Customer Service, Engagement, Consequences, Coaching, Empowerment, Fair Pay, Regard, Big Picture Thinking and Training.

35. A method as claimed at claim 21 wherein the factors relate to customer perception of a product or service business and members of the group comprise relevant customers of the business.

36. A method as claimed at claim 35 wherein the factors concerning customer satisfaction are selected from customer ratings of at least factors such as Customer Service, Proximity, Range, Cleanliness, Loyalty Cards, Rewards System, Green Products and Facilities.

37. A method as claimed at claim 35 wherein the product is an automobile and the factors concerning customer satisfaction are selected from customer ratings of at least factors such as Appearance, Quality, Reliability, Power, Handling, After-Sales Service, Parts Prices and Resale Value.
